(19) United States
(12) Patent Application Publication
(10) Pub. No.: US 2013/0329047 A1
(43) Pub. Date: Dec. 12, 2013

(54) ESCORT SECURITY SURVEILLANCE SYSTEM

(71) Applicants: Peter A. Jankowski, Rancho Santa Fe, CA (US); Rand D. Anderson, Cardiff, CA (US)

(72) Inventors: Peter A. Jankowski, Rancho Santa Fe, CA (US); Rand D. Anderson, Cardiff, CA (US)

(73) Assignee: Next Level Security Systems, Inc., Carlsbad, CA (US)

(21) Appl. No.: 13/490,355

(22) Filed: Jun. 6, 2012

(51) Int. Cl. H04N 7/18; G08B 21/02

(52) U.S. Cl. 348/158; 348/E07.085

(57) ABSTRACT

An escort security surveillance system is described. The system includes a gateway, a web server, a mobile communication device, and a client device of the gateway. The web server introduces the mobile communication device to a corresponding gateway based on a selection of a security monitoring service from the mobile communication device. The mobile communication device has an optical component and a microphone for generating media data. The gateway records a live stream of the media data. The gateway aggregates the media data from the mobile communication device and monitoring data generated by a security device coupled to the gateway. The aggregated data is stored in a storage device and communicated to the client device of the gateway.

### TECHNICAL FIELD

This application relates generally to the field of computer technology, and in a specific example embodiment, an escort security surveillance system for a mobile communication device.

### BACKGROUND

Emergency operators can efficiently dispatch appropriate first responders, such as emergency medical technicians (EMTs), police officers or firefighters, as a result of emergency calls. However, when an emergency call is placed by a person who is on a campus (work, school, etc. . . . ), the campus's safety organization is typically not notified of the emergency until after an incident has started.

As such, the campus safety organization has difficulties gathering any information about the emergency from the caller while the incident is happening. An emergency operator may require an oral description of the nature of the emergency, a victim's medical condition or history, a description of an assailant or other background information in order to properly respond to an emergency call. However, sometimes a caller's condition or situation renders the caller unable or unwilling to verbally provide this information. Under these circumstances, a proper assessment of the emergency may be delayed until the first responder arrives at the site of the emergency.

Furthermore, an assailant may destroy crucial evidence by stealing or breaking the mobile calling device of the victim, thereby preventing authorities from recovering pictures or audio recorded on the calling device during the incident. In such situation, the authorities need to rely solely on oral descriptions from the caller regarding the assailant and the incident.

### BRIEF DESCRIPTION OF THE DRAWINGS

The present invention is illustrated by way of example, and not by way of limitation, in the figures of the accompanying drawings in which:

FIG. 1A is a network diagram depicting a network system, according to one embodiment, for exchanging data over a network;

FIG. 1B is a network diagram depicting an escort security surveillance network system, according to an example embodiment;

FIG. 1C is a network diagram depicting an escort security surveillance network system, according to another example embodiment;

FIG. 2 is a block diagram illustrating an example embodiment of a mobile communication device;

FIG. 3A is a block diagram illustrating an example embodiment of an application in the mobile communication device;

FIG. 3B is a block diagram illustrating examples of monitoring services;

FIG. 4 is a block diagram illustrating an example embodiment of a gateway;

FIG. 5 is a block diagram illustrating another example embodiment of a gateway;

FIG. 6 is a block diagram illustrating an example embodiment of a web-based monitoring application of a gateway;

FIG. 7 is a block diagram illustrating an example embodiment of a web server;

FIG. 8A is a flow diagram of an example embodiment of a method for connecting a mobile communication device to a monitoring service;

FIG. 8B is a flow diagram of an example embodiment of a method for connecting a mobile communication device to a social network service as a monitoring service;

FIG. 9 is a flow diagram of an example embodiment of a method for directing a mobile communication device to a corresponding gateway;

FIG. 10 is a flow diagram of an example embodiment of a method for monitoring live data from a mobile communication device from a client device connected to a gateway;

FIG. 11 is a flow diagram of an example embodiment of a method for storing streaming data from a mobile communication device at a gateway; and

FIG. 12 shows a diagrammatic representation of machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In various embodiments, an escort security surveillance system is described. The system includes a gateway, a web server, a mobile communication device, and a client device of the gateway. The web server introduces the mobile communication device to a corresponding gateway based on a selection of a security monitoring service from the mobile communication device. The mobile communication device has an optical component and a microphone for generating media data. The gateway records a live stream of the media data. The gateway aggregates the media data from the mobile communication device and monitoring data generated by a security device coupled to the gateway. The aggregated data is stored in a storage device and communicated to the client device of the gateway.

In one embodiment, the gateway receives a request from the mobile communication device to start or stop the live stream of the media data from the mobile communication device.

The gateway can receive geographic location data of the mobile communication device. A security device associated with the gateway corresponds to the geographic location data of the mobile communication device.

The gateway can receive motion data generated by an accelerometer in the mobile communication device and detects an emergency based on the aggregated data and the motion data impact of the mobile communication device on the surface.

In another embodiment, the gateway generates an emergency notification to the client device associated with the gateway in response to detecting the emergency or receiving an alert request from the mobile communication device.

In another embodiment, the gateway generates a portion of the aggregated data as part of the emergency notification and forwards the portion of aggregated data to a computer of a law enforcement agency.

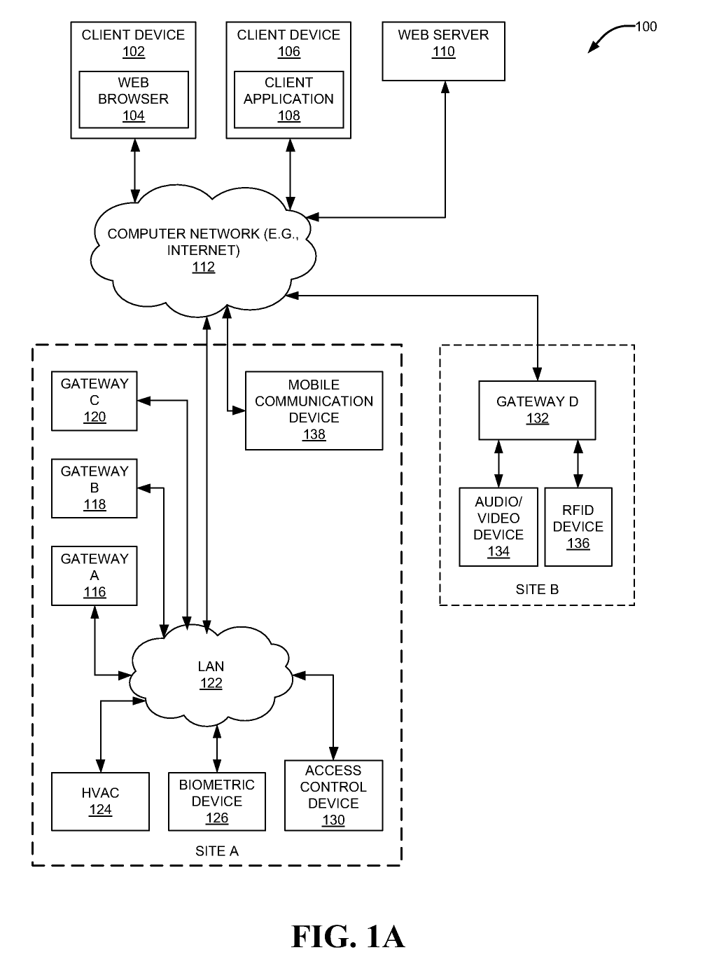

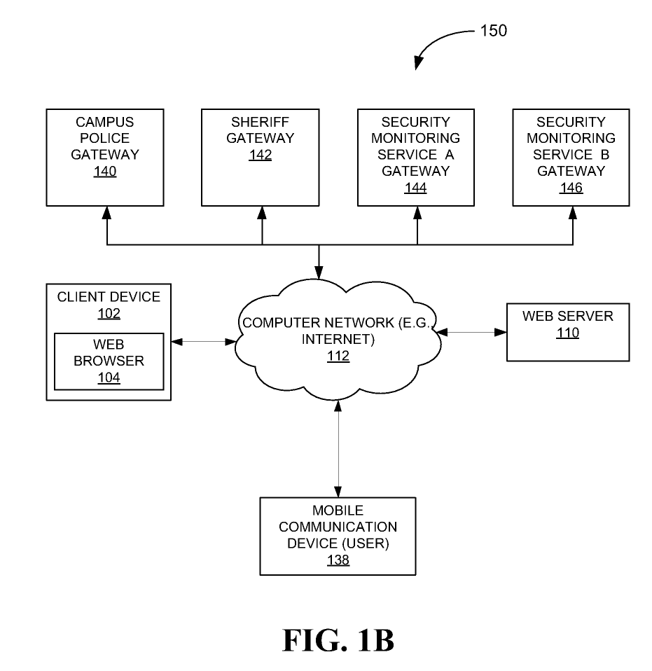

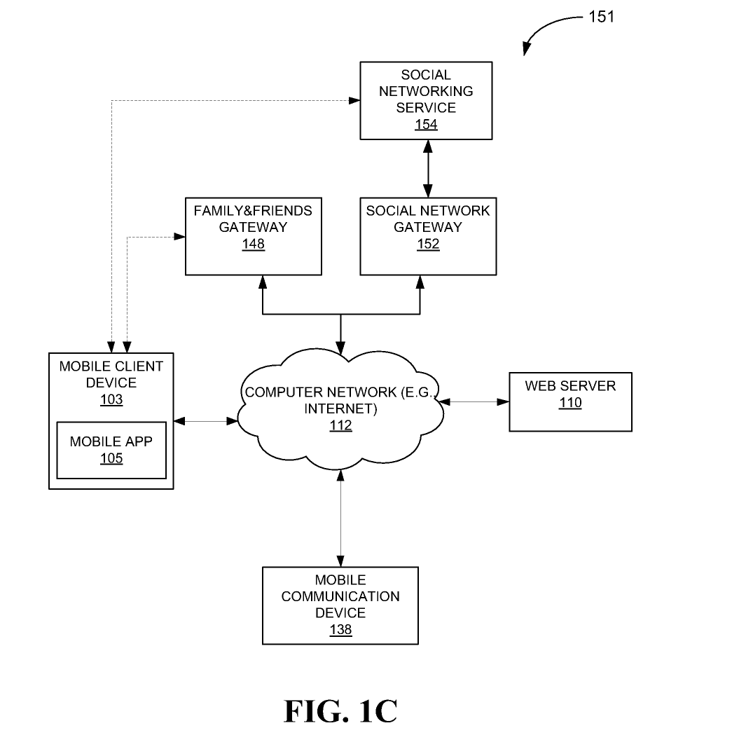

FIG. 1A is a network diagram depicting a network system 100, according to one embodiment, for exchanging data over a computer network 112 (e.g. TCP/IP network). For example, the network system 100 comprises client devices 102, 106, a web server 110, gateways 116, 118, 120 and a mobile communication device 138 at a location site A, and a gateway 132 at a location site B. For example, location site A may be a school campus in a city and location site B may be an office complex in another city. A location site may include, for example, one or more floors of an office building, a residential neighborhood, a school campus, a factory campus, an area of a factory or retail space, and so forth. In another example, location sites may overlap each other.

For purposes of the present embodiment, the terms “sites” and “premises” refer to any location to be monitored, whether residential, commercial, public, or secured. Further, the term “a” is generally used in the present disclosure to mean one or more. Still further, the terms “coupled” and “operatively coupled” mean connected in such a way that data may be exchanged. It is understood that “coupled” and “operatively coupled” do not require a direct connection, a wired connection, or even a permanent connection. It is sufficient for purposes of the present embodiment that the connection(s) be established for the sole purpose of exchanging information.

The mobile communication device 138 and the client devices 102, 106 are connected to the computer network 112. The mobile communication device 138 includes, for example, a smart phone with a camera, or a tablet. The client devices 102, 106 can include, but are not limited to, a desktop computer, a laptop computer, a mobile computing device, and the likes. A network interface means in the client devices 102, 106 and the mobile communication device 138 enable them to send and receive data to and from the computer network 112. The mobile communication device 138 may communicate indirectly via a cellular tower signal, directly via a wi-fi signal, or via other means to the network 112.

The client device 102 may include a web browser 104 that may be in communication with the web server 110 via the computer network 112. In another example, the client device 106 includes a programmatic client, such as a client application 108 configured to communicate with the web server 110 via the computer network 112. The web browser 104 or the client application 108 may be used to display some or all of the information and monitoring data provided by gateways 116, 118, 120, and 132.

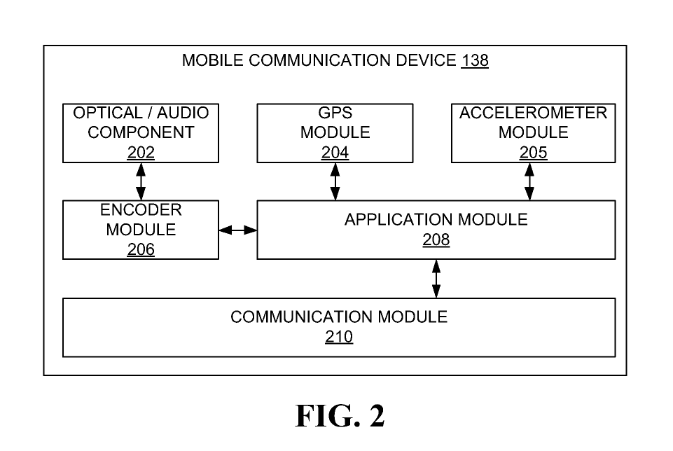

The mobile communication device 138 may include a web browser, a client application, or a mobile application (app) configured to access the web server 110 via the computer network 112, and to communicate with corresponding gateways. The mobile communication device 138 may be located at a site corresponding to a gateway (e.g., site A corresponding to gateways A 116). The mobile communication device 138 is described in more detail below with respect to FIG. 2.

The computer network 112 can include a local area network (LAN) where Gigabit Ethernet switches are used to switch data. In another example, the computer network 112 includes a wide area network, such as the Internet. In general, computer network 112 may be a public network or private network, a single network or a combination of several networks. In most embodiments, computer network 112 may be, but is not required to be, an IP-based network. In some embodiments, it may be desirable for all or a portion of network 112 to include publicly available networks, such as the Internet, to avoid the need for installing, purchasing, or leasing additional infrastructure.

The web server 110 may also connect to the computer network 112 both to receive and transmit data. The web server 110 may also be referred to as a web-based host. The web server 110 is connected to the computer network 112 by a means of a network interface. The network interface can take the form of a network interface card (not shown) installed within the web server 110 to enable data to sent and received to and from the computer network 112 by the web server 110.

In one embodiment, the web server 110 identifies one or more gateway(s) for the mobile communication device 138 and the client devices 102, 106 to communicate with, so as to monitor and/or control the security devices connected to the corresponding gateway(s). In another embodiment, the web server 110 may act as a directory service for client devices, gateways, and mobile communication devices.

In one embodiment, the web server 110 may provide server-side functionality, via the computer network 112, to the client devices 102, 106. The client devices 102, 106 may enable users that utilize the network system 100 and more specifically, the web server 110, to view monitoring data (e.g. audio/video feed) from security devices connected to gateways 116, 118, 120, and 132 over the computer network 112. These transactions may include transmitting, receiving (communicating) and processing data to, from, and regarding monitoring data and users of the network system 100. The data may include, but are not limited to audio, video, picture, metadata, camera configuration data, client device configuration data, and network data monitoring data. The web server 110 can provide other functions including storing monitoring data to an internal or external disk storage device (not shown), playing back recorded monitoring data.

In another embodiment, the client devices 102, 106 may view monitoring data (e.g. audio/video feed, lock status, etc. . . . ) from the camera/audio of the mobile communication device 138 over the computer network 112.

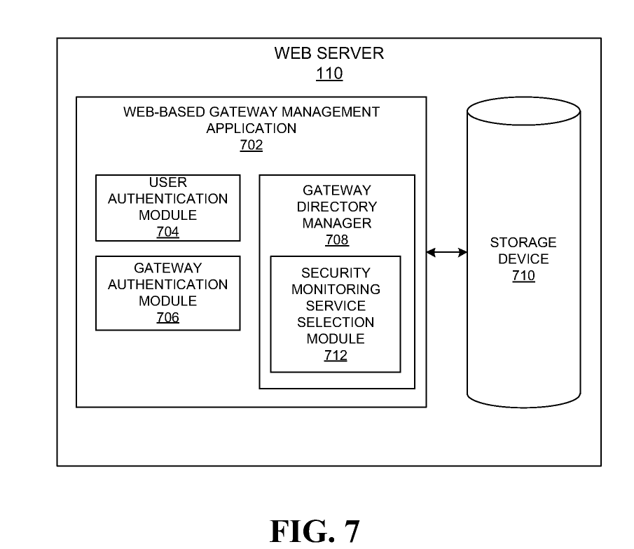

In one embodiment, the web server 110 may include a directory of security monitoring services (e.g, campus police, private third party monitoring service, sheriff, etc. . . . ), corresponding gateways (e.g., campus police gateway A, private third party monitoring service gateway D), and location of corresponding connected security devices of the gateways (e.g., camera one of gateway A located outside front entrance, camera two of gateway B located on first garage level, etc. . . . ). The web server 110 is described in more detail below with respect to FIG. 7.

As such, the web server 110 may correlate the gateway 116 at site A to the gateway 132 at site B. In one embodiment, the correlation may be generated pursuant to pre-defined settings or configuration based on user profile, organization topology, hierarchy, bandwidth and other factors. For example, a user at client device 102 may be a third party private operator responsible for monitoring stores or campuses located on the West coast. If both sites A and B are on the West coast, the web server correlates gateway 116 to gateway 132. As such, based on the user profile and the organization topology, the user can access only gateway 116 to obtain monitoring data from sites A and B. In other words, the user does not have to communicate directly with several gateways to monitor all security devices attached to the corresponding gateways. In another embodiment, the web server 110 may correlate gateway 116 with other gateways. In yet another embodiment, the other gateways may be correlated with other gateways. For example, information from other gateways correlated with the gateway 132 which is correlated with gateway 116 may be communicated with the user at the client device 102 or 106.

Generally, gateways 116, 118, 120, and 132 include a processor-based device that operate to record media from corresponding mobile communication devices, to aggregate the recorded media with information from security devices at the gateways, to detect an emergency situation based on the aggregated data, and to generate an alert notification to relevant parties (local law enforcement, third party monitoring service, etc. . . . ). The gateways may also monitors conditions at a target site or premise, analyze monitoring data, detect alarm conditions at the target site or premise, capture information relating to such alarm conditions, send such monitoring information to client devices 102, 106 and/or the web server 110.

Gateways 116, 118, and 120 are located at the same site A. In one embodiment, gateways 116, 118, 120 are capable of balancing their respective load. Furthermore, gateways 116, 118, 120 may provide a redundant backup of each other. Gateways 116, 118, 120 are connected to a local area network LAN 122. In another embodiment, gateways 116, 118, 120 communicate with one another via a peer-to-peer network.

Security devices (e.g. monitoring devices and controlling devices) 124, 126, and 130 are connected to the gateways 116, 118, 120 via LAN 122. Monitoring devices include, for example, sensors. The gateways are not limited to connect to any specific type or model of sensors or monitoring devices. Any sensor may be used, depending on the desired type and level of protection. Examples include, without limitation, microphones, cameras, magnetic contact switches, audio sensors, infrared sensors, motion detectors, fire alarms, and carbon monoxide sensors. For illustration purposes, location site A in FIG. 1A includes a biometric device 126 (e.g. fingerprint reader), and an access control device 130 (e.g. door/gate access sensor).

In addition, controlling devices may include devices that can be controlled such as a HVAC system 124 (e.g. heater/air conditioning system including thermometer, smoke sensor, thermostat), a gate/door lock, a camera positioning system (e.g. tilt, pan).

The HVAC system 124, the biometric devices 126, and the access control device 130 are located at site A and are connected to the gateway 116 via LAN 122.

The gateway 132 is located at another location site B away from location site A (e.g. different physical locations). An audio/video device 134 (e.g. camera, microphone) and an RFID device 136 (e.g. card reader) are directly connected to gateway 132. The gateway 132 communicates with the computer network 112.

In another embodiment, gateways 116, 118, and 120 from site A communicate with the gateway 132 from site B. As such, client devices 102, 106 can monitor data from audio/video device 134 and RFID device 136 connected to the gateway 132 by communicating only with the gateway 116. Similarly, client devices 102, 106 can monitor data from the HVAC 124, the biometric device 126, and the access control device 130 connected to gateway 116 by communicating only with the gateway 132.

FIG. 1B is a network diagram depicting an escort security surveillance network system 150, according to an example embodiment. For example, the escort security surveillance network system 150 includes the client device 102, the web server 110, a campus police gateway 140, a sheriff gateway 142, a security monitoring service A gateway 144, a security monitoring service B gateway 146, and a mobile communication device 138.

A user on the mobile communication device 138 selects a monitoring service. The web server 110 receives the request identifying the selected monitoring service and determines the gateway corresponding to the selected monitoring service. The web server 110 then introduces the mobile communication device 138 to the corresponding gateway. For example, if the user of the mobile communication device 138 selects campus police, the mobile communication device 138 is directed to communicate with the campus police gateway 140. The mobile communication device 138 then stream media data to the campus policy gateway 140. An operator at a client device associated with the campus police gateway 140 may monitor the media data for any sign of danger or emergency. For example, the operator may access the web browser 104 at client device 102 to access the streamed media data. If the operator detects sign of danger from the stream media and the security devices coupled to the gateway, the operator may notify local law enforcement for help.

In another embodiment, the user of the mobile communication device 138 may manually send an emergency help request notification to the campus police gateway 140 that generates an alert notification to the operator at the client device 102.

In another embodiment, the gateway may detect a dangerous situation when the stream media includes a scream, a shotgun, glass shattering, or any other predefined noise, ambient noise level, key language (“help”), or code language. The gateway may also detect a dangerous situation when an image from the stream media or from the security devices includes a facial recognition match with a sex offender database or other public or private database of formerly convicted persons. The gateway may also detect a dangerous situation when security devices in proximity to the location of the mobile device indicate a breach. For example, the gateway may detect a private door has been recently breached while the mobile device is in a geographic location in proximity (within a predetermined radius) of the private door.

FIG. 1C is a network diagram depicting an escort security surveillance network system 151, according to another example embodiment. The escort security surveillance network system 151 includes a mobile client device 103 (e.g., smartphone) having a mobile application 105, the web server 110, a family and friends gateway 148, a social network gateway 152 communicating with a social networking service 154, and a mobile communication device 138.

A user on the mobile communication device 138 selects a monitoring service. For example, the user may identify specific friends or family members from the family and friends gateway 148 that the user wishes to be monitored by. In another example, the user may select a group of friends from the user's social network of the social networking service 154 via social network gateway 152. Identified family members or selected friends from the social network of the user may monitor the user on their respective mobile client device 103. The mobile application 105 communicates with the corresponding gateway 148 or 152 to retrieve location data from the user of the mobile communication device 138.

The web server 110 receives the request from the user identifying the selected monitoring service (e.g., specific family members or friends from a social network) and determines the gateway corresponding to the selected monitoring service (e.g., family and friends gateway 148, social network gateway 152). The web server 110 then introduces the mobile communication device 138 to the corresponding gateway.

The mobile communication device 138 then stream media data to the corresponding gateway 148, 152. Friends or family members at corresponding mobile client device 103 associated with the corresponding gateway may monitor some or all of the media data for any sign of danger or emergency. For example, the friend at mobile client device 103 may access the mobile application 105 at to access the streamed media data. If the friend or family member detects sign of danger from the stream media, the friend may notify local law enforcement for help.

For example, the mobile client device 103 may receive a travel itinerary comprising a starting geographic location and a destination geographic location from the mobile communication device 138. The gateway 148 may generate an estimate of time travel based in travel information. The travel information may include for example, time of departure, estimated time of arrival, route, and type of travel (i.e. by walking, automobile, bus or train). In another embodiment, the gateway may learn from frequent routes used by the user.

The mobile client device 103 can monitor a live location of the mobile communication device 138 and a virtual trail of breadcrumbs. The route of the user may be traced with a GPS breadcrumb trial over time which can be used with a digital map to see progress and could update the estimate time of arrival. If the mobile communication device 138 has not reached a waypoint or the destination by a computed or estimated time, an alert notification may be sent to the mobile client device 103. For example, an email, sms text or automated phone call can be sent to the selected friends, colleagues or family members.

When a user has gone past the expect time of arrival by a certain threshold, an alert can be sent to the friends, colleagues and family members to check up on the user. If there is an extended certain threshold of delay, then the proper authorities can be sent a message to try to connect with the user and an attempt to contact the user will be made.

In one embodiment, the mobile client device 103 may receive live location data from the mobile communication device 138 while gateway 148, 152 receive and record all media data streamed from the mobile communication device 138.

In another embodiment, the user of the mobile communication device 138 may manually send an emergency help request notification to his friends via gateways 138, 140 that generate an alert notification to the mobile client device 103. If an emergency or duress button on the mobile communication device 138 is selected then the friends, colleagues and family members can be notified along with the proper emergency authorities.

In another embodiment, the gateways 148, 152 may detect a dangerous situation when the stream media includes a scream, a shotgun, glass shattering, or any other predefined noise, ambient noise level, key language (“help”), or duress code. The gateways 148, 152 may also detect a dangerous situation when an image from the stream media or from the security devices includes a facial recognition match with a sex offender database or other public or private database of formerly convicted persons.

The gateways 148, 152 may also detect a dangerous situation when security devices in proximity to the location of the mobile device indicate a breach. For example, the gateways 148, 152 may detect a private door has been recently breached while the mobile device is in a geographic location in proximity (within a predetermined radius) of the private door.

The gateways 148, 152 may also detect if the mobile communication device 138 is heading towards a high crime area based on time, date, and location. The high crime area may be determined based on public crime statistics data of the area. Thus, if the user is going near an area of danger (high crime), the user can be notified to modify their route.

In response to detecting dangerous situations, the gateway may send an alert to the mobile communication device 138 and the mobile client device 103.

FIG. 2 is block diagram of an example embodiment of the mobile communication device 138. The mobile communication device 138 includes an optical/audio component 202, a gps module 204, an accelerometer module 205, an encoder 206, an application module 208, and a communication module 210.

The optical/audio component 202 includes, for example, an optical device such as a camera lens for capturing a picture or video data and/or a microphone for capturing sound. The optical/audio component 202 may capture an analog or digital video and/or audio data. The video and audio data are captured by the optical/audio component 202 in raw format. The encoder module 206 receives the raw video/audio and is configured to encode the video in a variety of formats (MPEG 2, MPEG4, MP3, etc. . . . ). The communication module 210 communicates the encoded media data (audio data and/or video data) to a corresponding gateway. The communication module 210 may include a network interface configured to communicate with the computer network 112 of FIG. 1. The GPS module 204 comprises a location detection component configured to determine a geographic location of the mobile communication device 138. The location data generated by the GPS module 204 is associated with the encoded video data from the encoder module 206. The accelerometer module 205 determines a direction and movement of mobile communication device 138 and generates a motion data. In one embodiment, the motion data may also be included in the media data as meta data.

The application module 208 enables the wireless mobile communication device 138 to authenticate a user with the web server 110 and corresponding gateways introduced by the web server 110. In one embodiment, the application module 208 allows the user at the mobile communication device 138 to record video/audio and stream the media data to the corresponding gateway.

In another embodiment, the application module 208 allows a user at the mobile communication device 138, upon authentication of appropriate privileges, to monitor security devices associated with a gateway.

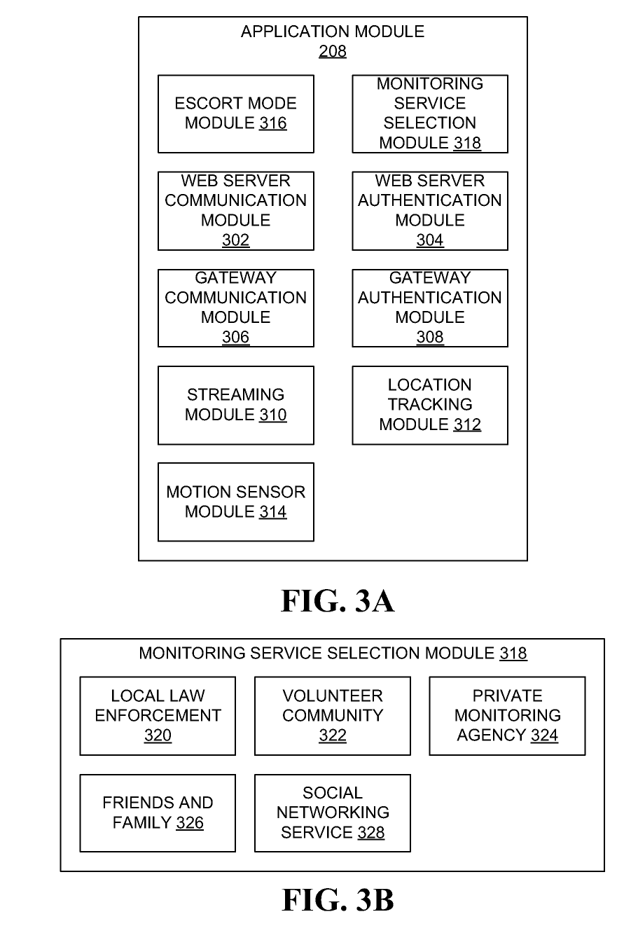

FIG. 3A illustrates an example embodiment of the application module 210. The application module 210 includes a web server communication module 302, a web server authentication module 304, a gateway communication module 306, a gateway authentication module 308, a streaming mode module 310, a location tracking module 312, a motion sensor module 314, an escort mode module 316, and a monitoring service selection module 318.

The escort mode module 316 detects a request from the mobile communication device 138 for an escort service. The user may need a virtual escort from a building of a school campus to a car in a parking lot.

The monitoring service selection module 318 receives a request from the user of the mobile communication device 138 to use a particular security monitoring service (e.g., campus police, sheriff, security monitoring service A, security monitoring service B, family members, or friends from a social network). FIG. 3B illustrates examples of monitoring services: local law enforcement 320, volunteer community 322, private monitoring agency 324, friends and family 326, and social networking service 328.

The web server communication module 302 is configured to enable the communication device 138 to contact and communicate with the web server 110. The web server authentication module 304 authenticates a user of the mobile communication device 138 with the web server 110. Upon successful authentication, the web server 110 introduces the wireless mobile communication device 138 to a corresponding gateway associated with the user or with the wireless mobile communication device 138 corresponding to the selected security monitoring service. The gateway communication module 306 is configured to enable the mobile communication device 138 to communicate with the corresponding gateway. The gateway authentication module 308 authenticates a user of the mobile communication device 138.

The streaming mode module 310 enables a user of the mobile communication device 138 to capture media (e.g., video/audio) data with the mobile communication device 138 and stream the video/audio data to the corresponding gateway associated with the selected security monitoring service.

The location tracking module 312 enables the mobile communication device 138 to send a geographic location (e.g., GPS coordinates) of the mobile communication device 138 to the corresponding gateway associated with the selected security monitoring service.

The motion sensor module 314 enables the mobile communication device 138 to send motion data from the accelerometer of the mobile communication device 138 to detect any abrupt motion such as, for example, the mobile communication device 138 being dropped on the ground.

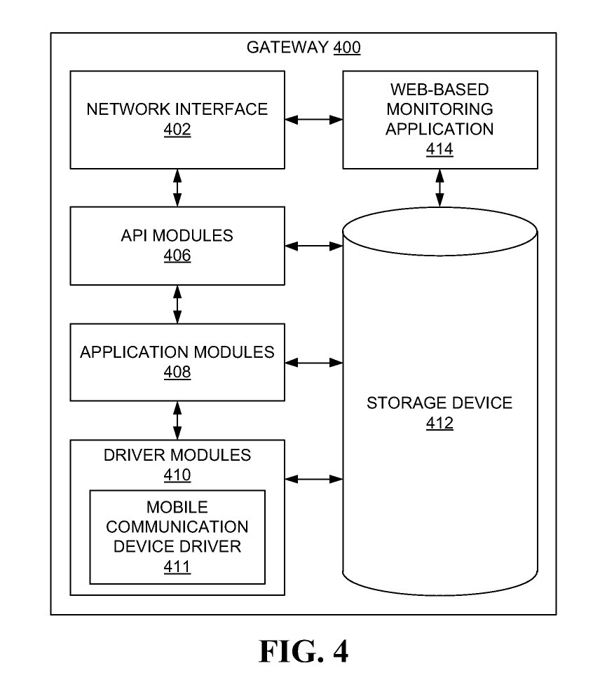

FIG. 4 is a block diagram illustrating an example embodiment of a gateway 400. The gateway 400 includes a network interface 402, API modules 406, application modules 408, driver modules 410, a web-based monitoring application 414, and a storage device 412. The network interface 402 enables the gateway 400 to communicate with the computer network 112. The application programming interface (API) modules 406 enable the gateway 400 to interface the gateway 400 with the wireless mobile communication device 138, the client devices 102, 106, the web server 110, and other third party devices (not shown). The application modules 408 enable the gateway 400 to monitor or control the corresponding monitoring or controlling devices connected to the gateway 400. In addition, the application modules 408 enable the gateway 400 to provide add-on expandable services discussed further below. The driver modules 410 include device drivers to enable interaction of the application modules 408 with the hardware of the corresponding monitoring or controlling devices. In one embodiment, the driver modules 410 includes a wireless mobile communication device driver 411 configured to interface with the camera of the wireless mobile communication device 138.

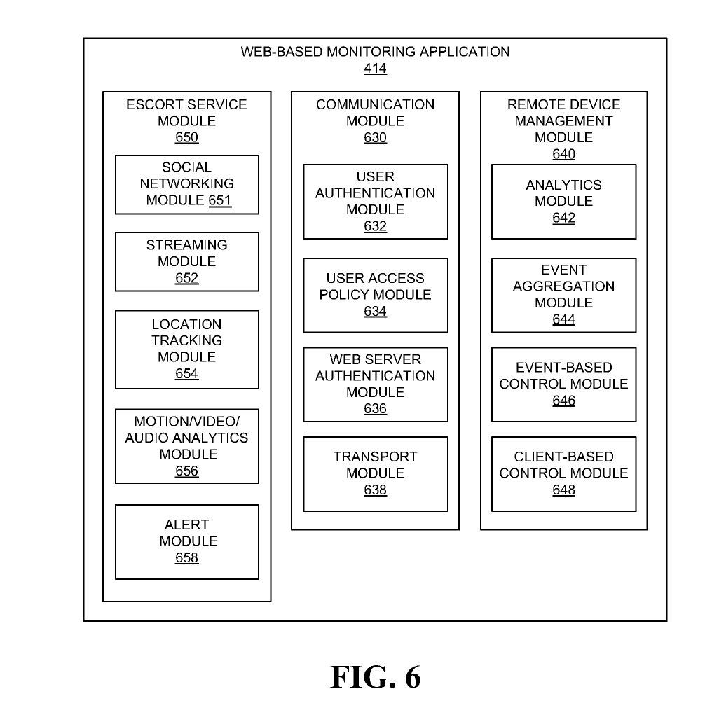

The web-based monitoring application 414 enables the gateway 400 to communicate monitoring and controlling data to and from the client devices. The web-based monitoring application 414 is discussed in more detail with respect to FIG. 6. The storage device 412 may be used to store video data from the wireless mobile communication device 138, monitoring data from the monitoring devices connected to the gateway 400, APIs from API modules 406, software application from application modules 408, device drivers from driver modules 410, and a configuration of the gateway 400. For example, the configuration of the gateway 400 may include a topology or hierarchy of at a user level, organization level, partner level. The configuration of the gateway may include specifically an enterprise configuration of gateway (based on the topology/hierarchy previously mentioned). In one embodiment, the configuration of the gateway 400 may be replicated to other gateways that are correlated by the web server based on the topology/hierarchy. For example, some gateway can have access control to a limited number of security devices. In another embodiment, each gateway may be custom configured. In another embodiment, the gateway 400 is configured to aggregate data from multiple gateways (that may be correlated by the web server 110 based on the topology) and present the aggregated data to the client device.

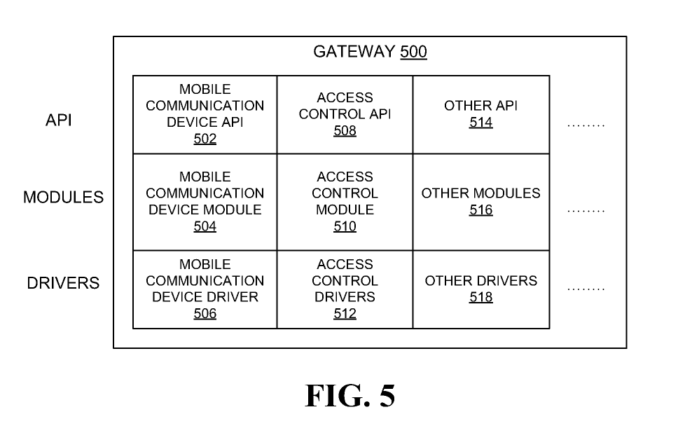

FIG. 5 is a block diagram illustrating another example embodiment of a gateway 500. For example, the gateway 500 includes a mobile communication device API 502, a mobile communication device module 504, and a mobile communication device driver 506. The mobile communication device API 502 provides an interface to the web browser 104 or the client application 108 of the client device 106 to receive and send data from the mobile communication device associated with the gateway 500. The mobile communication device module 504 enables the client device 106 to receive data (e.g. audio and/or video) from the camera of the mobile communication device via the mobile communication device API 502. In another embodiment, the mobile communication device application module 504 enables the client device 106 to send requests (e.g. focus, tilt, pan, zoom) to the mobile communication device via the mobile communication device API 502. The mobile communication device driver 506 includes one or more drivers for different brand or manufacturer of wireless mobile communication devices.

In another example, the gateway 200 also includes an access control API 508, an access control application module 510, and access control drivers 512. The access control API 508 provides an interface to the web browser 104 or the client application 108 of the client device to receive and send data from an access control device (e.g. a door access at a monitored site) connected to the gateway 500. The access control module 510 enables the client device to receive data (e.g. time and ID log of the door access at the monitored site) from the access control device via the access control API 508. In another embodiment, the access control module 510 enables the client device to send data to the access control device (e.g. open, close, lock door) to the access control device via the access control API 508. The access control drivers 512 include one or more drivers for different brand or manufacturer of access control devices.

One advantage of one of the embodiments of the gateway 500 is the ability to easily connect additional devices or third party devices. This is illustrated with respect to other APIs 514, other module 516, and other drivers 518. As such, the gateway 500 is not limited to any particular manufacturer of devices or brand of devices. The gateway 500 allows for easy expansion and plug-in features using additional APIs, corresponding modules, and corresponding device drivers.

FIG. 6 is a block diagram illustrating an example embodiment of the web-based monitoring application 414 of the gateway 400. The web-based monitoring application 414 enables client devices to remotely monitor streaming data from connected mobile communication devices. In another embodiment, the web-based monitoring application 414 enables client devices to monitor and control monitoring and controlling devices connected to the gateway 400 via the web browser 104 or the client application 108 at the client devices 102, 106.

In one embodiment, the web-based monitoring application 414 includes a communication module 630, a remote devices management module 640, and an escort service module 650.

The escort service module 650 receives a request from the mobile communication device to start or stop the live stream of the media data from the mobile communication device. In one embodiment, the escort service module 650 includes a social networking module 651, a streaming module 652, a location tracking module 654, a motion analysis module 656, and an alert module 658.

The social networking module 651 communicates with a social networking service from the user of the mobile communication device.

The streaming module 652 receives and records a live stream of the media data from the mobile communication device 138 after the selection of the security monitoring service on the mobile communication device 138.

The location tracking module 654 receives geographic location data of the mobile communication device 138.

The motion/video/audio analytics module 656 receives video, audio, and motion data generated by an accelerometer in the mobile communication device 138. The analytics module 656 can detect an impact of the mobile communication device 138 on a surface (e.g., ground) with the motion data. The analytics module 656 can use facial recognition to detect an emergency or a dangerous situation. The analytics module 656 can analyze audio to detect an emergency or a dangerous situation.

The alert module 658 generates an alert notification and emergency notification to the client device of the gateway in response to detecting the emergency.

In another embodiment, the alert module 658 receives an alert request from the mobile communication device 138, and generates an emergency notification to the client device of the gateway in response to receiving the alert request.

In another embodiment, the alert module 658 generates a portion of the aggregated data as part of the emergency notification, and forwards the portion of aggregated data to a computer of a law enforcement agency in response to receiving the alert request.

In another embodiment, the alert module 658 detects an emergency based on the aggregated data, and generates an emergency notification to the client device in response to detecting the emergency. For example, the alert module detects the emergency when a scream or a gunshot is detected from the aggregated data.

The communication module 630 enables communication between the gateway 400 and the client devices 102, 106. The remote devices management module 640 enables the client devices 102, 106 to monitor or control the monitoring or controlling devices connected to the gateway 400.

For example, the communication module 630 includes a user authentication module 632, a user access policy module 634, a web server authentication module 636, and a transport module 638.

The user authentication module 632 authenticates a user at the client device or at a wireless mobile communication device based on a user profile of the user. An example of user authentication may include verifying the username and password provided by the wireless mobile communication device with a predefined user profile. The predefined user profile may be stored in the storage device 412 or at the web server 110.

The user access policy module 634 limits or grants the user at the client device or at the wireless mobile communication device access to the monitoring and/or controlling devices connected to the gateway. For example, a user with limited privilege may have access to the monitoring data to a particular site (e.g. first floor only) or a specific monitoring device (e.g. HVAC only). On the other hand, a user with executive privilege may not only be able to view monitoring data and control security devices from more sites.

The web server authentication module 636 authenticates a communication between the gateway 400 and the web server 110. For example, the gateway transmits a unique token to the web server 110 for authentication prior to establishing the secured communication. Those of ordinary skills in the art will recognize that other means of authentication between the gateway and the web server 110 may be used.

The transport module 638 enables peer-to-peer communication between gateways. As such, a client device communicating with one gateway at a first location is also able to communicate with another gateway at a second location.

For example, the remote device management module 640 of the web-based monitoring application 414 includes an analytics module 642, an event aggregation module 644, an event-based control module 646, and a client-based control module 648.

The analytics module 642 analyzes audio/video, and other detected changes from the monitoring devices and generates events based on the analysis. For example, the analytics module 642 is capable of determining how many people have entered or left an activity zone (e.g. a room, a hallway) in a video feed, the direction of the movement of individuals in a video feed, the temperature of individuals in a video feed, facial recognition of individual in a video feed, and so forth. Events are generated based on the analysis and predefined user-configured settings. A user at the client device is able to configure the conditions for generating an event from the web browser 104 of the client device 102 or the client application 108 of the client device 106.

The event aggregation module 644 aggregates events generated from the analytics module 642. For example, events generated based on the analysis and predefined/user-configured settings are aggregated in a log stored in a storage device attached to the gateway, in a storage device attached to another gateway, in a storage device attached to the web server 110, or in a storage device connected to the client device.

The event-based control module 646 communicates a command to at least one controlling device connected to the corresponding gateway based on an event identified in event aggregation module 644 based on an event configuration. For example, an event comprises a temperature of a room reaching a predefined maximum temperature. The event-based control module 646 may communicate to the HVAC system to turn on the air conditioning system for the room if such event occurs.

The client-based control module 648 communicates a command to one or more controlling devices of the corresponding gateway based on a command initiated and communicated from the client device. For example, a user at the client device or at a wireless mobile communication device may initiate a command to pan a camera connected to the gateway. Such command would be communicated to the camera via the client-based control module 648.

FIG. 7 is a block diagram illustrating an example embodiment of a web server 110 also referred to as a web-based host. The web server 110 comprises a web-based gateway management application 702 and a storage device 710. The web-based gateway management application 702 identifies a gateway associated with a user at the client device or the wireless mobile communication device, authenticates with the user at the client device or the wireless mobile communication device, and authenticates with the identified gateway.

In one embodiment, the web-based gateway management application 702 includes a gateway directory manager 708, a user authentication module 704, and a gateway authentication module 706. The gateway directory manager 708 identifies a gateway associated with a user profile. For example, a user may only be able to access a particular gateway or a particular set of devices connected to a gateway. As such, a security manager of an organization may be able to access monitored sites only from west coast stores of the organization. In contrast, a security manager with higher privileges may be able to access more gateways and devices.

In another embodiment, the gateway directory manager 708 includes a security monitoring service selection module 712 to enable the mobile device to select a monitoring service as previously described.

The user authentication module 704 authenticates the web server 110 with the user at the client device or the wireless mobile communication device based on the user profile. For example, the web server 110 verifies the username and password of the user at the client device or the wireless mobile communication device.

The gateway authentication module 706 authenticates the identified gateway. For example, the web server 110 receives a unique token from the identified gateway to authenticate the identified gateway prior to establishing secured communication between the web server and the gateway.

The storage device 710 may be used to store user profiles, tokens from gateways, a directory of gateways with corresponding devices, services from the gateways, a directory of gateways associated with a user profile, and a directory of connected security devices associated with a user profile.

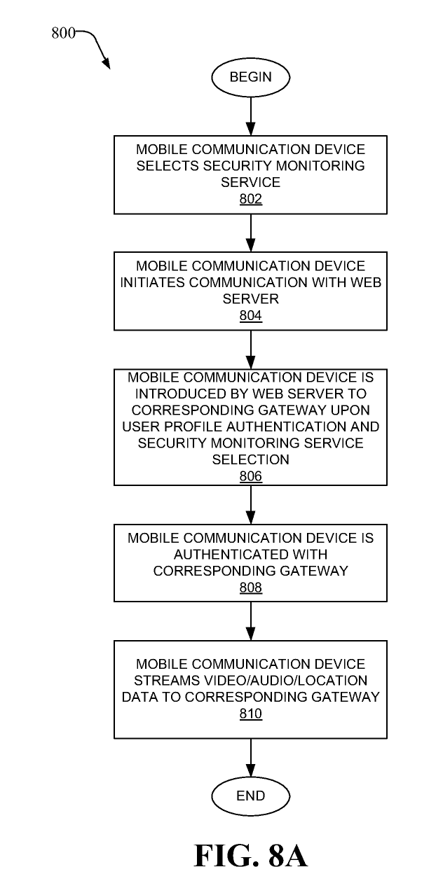

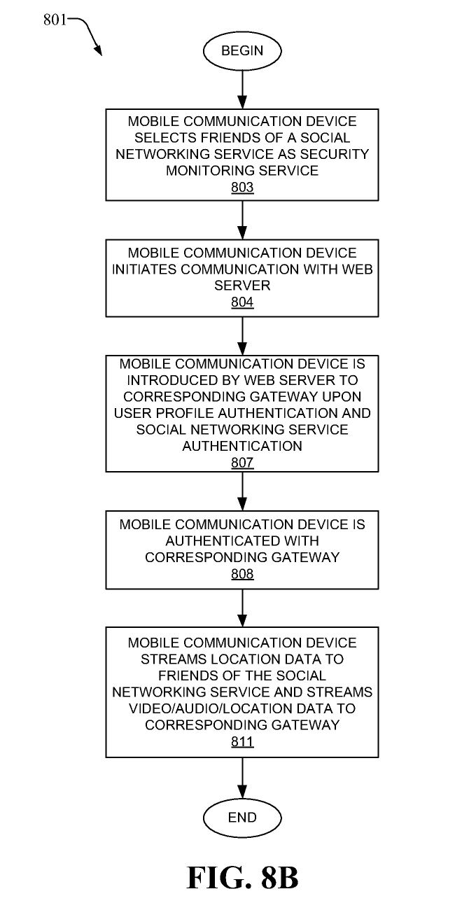

FIG. 8A is a flow chart 800 of one embodiment of an example method for connecting a mobile communication device to a monitoring service. At operation 802, a user of a mobile communication device initiates a request for a virtual escort and selects a security monitoring service from the mobile communication device. At 804, the mobile communication device initiates communication with a web server to be connected to a corresponding gateway associated with the selected security monitoring service. At operation 806, the web server directs/introduces the mobile communication device to the corresponding gateway based on the user profile of the user of the wireless mobile communication device and the selection of the security monitoring service. At operation 808, the mobile communication device is authenticated with the corresponding gateway. At operation 810, the mobile communication device is able to stream data to the identified gateway(s). In one embodiment, the client device of the gateway receives an aggregated view of all security devices and the mobile communication device from several correlated gateways by communicating with only one gateway.

FIG. 8B is a flow chart 801 of one embodiment of an example method for connecting a mobile communication device to a monitoring service. At operation 803, a user of a mobile communication device initiates a request for a virtual escort from his friends and selects friends from a social networking service as a security monitoring service from the mobile communication device. At 804, the mobile communication device initiates communication with a web server to be connected to a corresponding gateway associated with the selected security monitoring service. At operation 807, the web server directs/introduces the mobile communication device to the corresponding gateway based on authentication of the user profile and the social networking service. At operation 808, the mobile communication device is authenticated with the corresponding gateway. At operation 811, the mobile communication device is able to stream location data to selected friends of the social networking service and stream media data and location data to the identified gateway(s). In one embodiment, the client device of the gateway receives an aggregated view of all security devices and the mobile communication device from several correlated gateways by communicating with only one gateway.

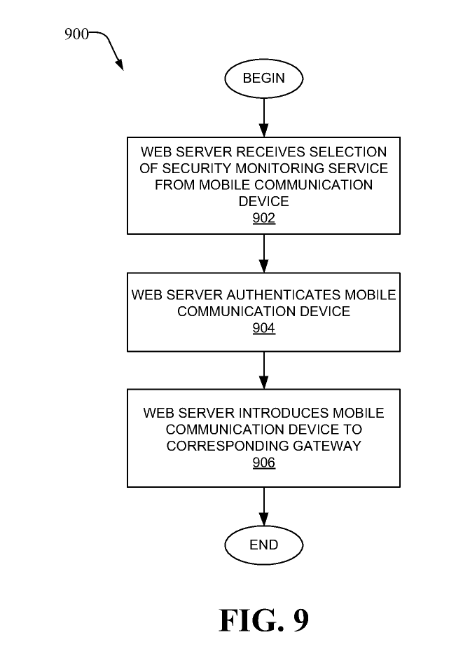

FIG. 9 is a flow chart 900 of one embodiment of an example method for directing a mobile communication device to a corresponding gateway. At operation 902, a web server receives a selection of a security monitoring service from a mobile communication device. At operation 904, the web server authenticates the mobile communication device based on a user profile. At operation 906, the web server refers and introduces the mobile communication device to the corresponding gateway(s) associated with the security monitoring service selected by the user at the mobile communication device.

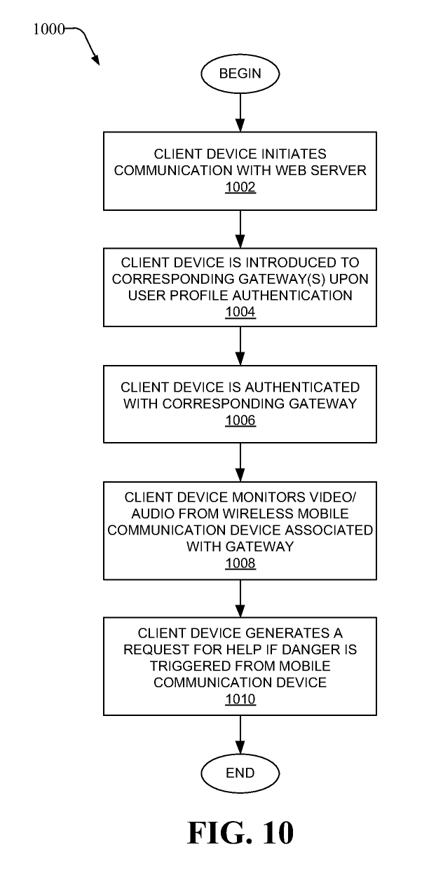

FIG. 10 is a flow chart 1000 of one embodiment of an example method for monitoring live data from a mobile communication device from a client device connected to a gateway. At operation 1002, the client device initiates a communication with a pre-identified web server. At operation 1004, the client device is introduced to one or more corresponding gateway after authentication of the user at the client device. At operation 1006, the client device is authenticated with the corresponding gateway. At operation 1008, the client device monitors video and/or audio data from the mobile communication device associated with the gateway. At operation 1010, the client device generates a request for help to local authorities if danger is triggered or detected from streamed media of the mobile communication device and other data from security devices connected to the gateway.

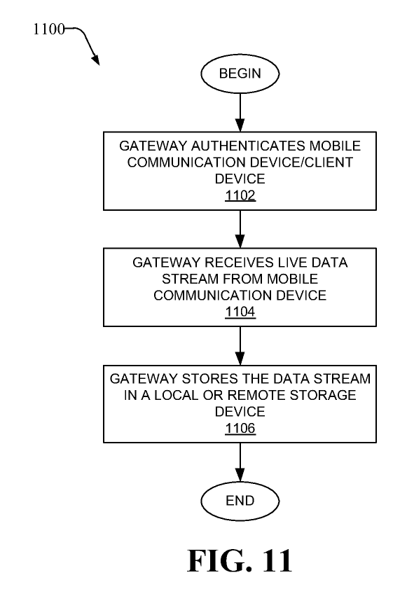

FIG. 11 is a flow diagram of an example embodiment of a method for storing streaming data from a mobile communication device at a gateway. At 1102, the gateway authenticates the mobile communication device and client device. At 1104, the gateway receives live streaming data from the mobile communication device. At 1106, the gateway stores the data stream in a local or remote storage device.

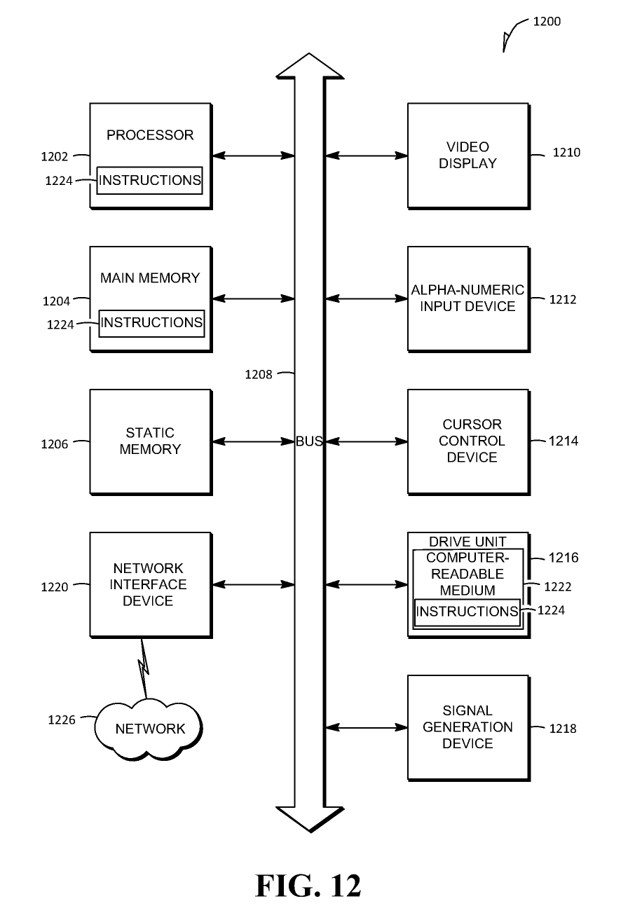

FIG. 12 shows a diagrammatic representation of machine in the example form of a computer system 1100 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

The disk drive unit 1216 includes a machine-readable medium 1222 on which is stored one or more sets of instructions and data structures (e.g., software 1224) embodying or utilized by any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media.

The software 1224 may further be transmitted or received over a network 1226 via the network interface device 1220 utilizing any one of a number of well-known transfer protocols (e.g., HTTP).

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A gateway comprising:
a communication module configured to communicate with a mobile communication device introduced to the gateway by a web server based on a selection of a security monitoring service from the mobile communication device, the gateway associated with the selected security monitoring service, the mobile communication device having an optical component and a microphone for generating media data;
an escort service module configured to record a live stream of the media data from the mobile communication device after the selection of the security monitoring service on the mobile communication device; and
a remote device management module configured to aggregate the media data from the mobile communication device and monitoring data generated by a security device coupled to the gateway, to store the aggregated data in a storage device coupled to the gateway, and to communicate the aggregated data to a client device of the gateway.

2. The gateway of claim 1, wherein the escort service module further comprises:
a location tracking module configured to receive geographic location data of the mobile communication device.

3. The gateway of claim 1, wherein the escort service module further comprises:
a social networking module configured to communicate the geographic location data of the mobile communication device to a social network of a user of the mobile device from a social networking service.

4. The gateway of claim 2, wherein the security device corresponds to the geographic location data of the mobile communication device.

5. The gateway of claim 1, wherein the escort service module further comprises:
a motion analytics module configured to receive motion data generated by an accelerometer in the mobile communication device, and detect an emergency based on an impact of the mobile communication device on a surface with the motion data.

6. The gateway of claim 1, wherein the escort service module further comprises:
an audio analytics module configured to receive audio data from the mobile communication device and the security device, and to detect an emergency based on an analysis of the audio data.

7. The gateway of claim 1, wherein the escort service module further comprises:
a video analytics module configured to receive video data from the mobile communication device and the security device, and to detect an emergency based on an analysis of the video data.

8. The gateway of claim 1, wherein the escort service module further comprises:
an alert module configured to generate an emergency notification to the client device in response to an emergency detected by a motion analysis module, an audio analysis module, or a video analysis module.

9. The gateway of claim 3, wherein the escort service module further comprises:
an alert module configured to generate an emergency notification to the social network of the user of the mobile device in response to an emergency detected by a motion analysis module, an audio analysis module, or a video analysis module, the emergency notification comprising a portion of the aggregated data, and to forward the portion of aggregated data to a law enforcement agency in response to the emergency notification.

10. The gateway of claim 1, wherein the escort service module further comprises:
an alert module configured to receive an alert request from the mobile communication device, to generate an emergency notification to the client device in response to receiving the alert request, the emergency notification comprising a portion of the aggregated data, and to forward the portion of aggregated data to a law enforcement agency in response to receiving the alert request.

11. The gateway of claim 1, wherein the escort service module further comprises:
an alert module configured to detect an emergency based on the aggregated data, and to generate an emergency notification to the client device in response to detecting the emergency.

12. The gateway of claim 1, wherein the communication module comprises:
a user authentication module configured to authenticate a user at the mobile communication device based on a profile of the user;
a user access policy module configured to limit or grant the user at the mobile communication device access to the security device;
a web server authentication module configured to authenticate a communication between the gateway and the web server; and
a transport module configured to enable peer-to-peer communication between gateways, the mobile communication device, and the web server.

13. The gateway of claim 12, wherein the remote device management module comprises:
an analytics module configured to analyze the aggregated data and to generate events based on the analysis;
an event aggregation module configured to aggregate events generated from the analytics module;
an event-based control module configured to communicate a first command to the security device based on an event identified in the aggregated events based on an event configuration; and
a client-based control module configured to communicate a second command to the security device of the gateway based on a command communicated from the mobile communication device.

14. The gateway of claim 1, wherein the web server comprises a web-based gateway management application comprising:
a gateway directory manager configured to identify the gateway associated with the security monitoring service selected from the mobile communication device;
a user authentication module configured to authenticate with the user of the mobile communication device based on a profile of the user; and
a gateway authentication module configured to authenticate the identified gateway,
wherein the gateway directory manager comprises a security monitoring service selection module configured to receive the selection of the security monitoring service from the user.

15. A method comprising:
communicating with a mobile communication device introduced to a gateway by a web server based on a selection of a security monitoring service from the mobile communication device, the gateway associated with the selected security monitoring service, the mobile communication device having an optical component and a microphone for generating media data;
recording a live stream of the media data from the mobile communication device after the selection of the security monitoring service on the mobile communication device; and
aggregating the media data from the mobile communication device and monitoring data generated by a security device coupled to the gateway;
storing the aggregated data in a storage device coupled to the gateway; and
communicating the aggregated data to a client device of the gateway.

16. The method of claim 15, further comprising:
receiving geographic location data of the mobile communication device; and
communicating the geographic location data of the mobile communication device to a social network of a user of the mobile device from a social networking service.

17. The method of claim 15, further comprising:
receiving motion data generated by an accelerometer in the mobile communication device, and detecting an emergency based on an impact of the mobile communication device on a surface with the motion data;
receiving audio data from the mobile communication device and the security device, and to detecting an emergency based on an analysis of the audio data; and
receiving video data from the mobile communication device and the security device, and to detecting an emergency based on an analysis of the video data.

18. The method of claim 17, further comprising:
generating an emergency notification to the client device in response to the detected emergency, the emergency notification comprising a portion of the aggregated data; and
forwarding the portion of aggregated data to a law enforcement agency in response to the detected emergency.

19. The method of claim 15, further comprising:
receiving an alert request from the mobile communication device;
generating an emergency notification to the client device in response to receiving the alert request, the emergency notification comprising a portion of the aggregated data; and
forwarding the portion of aggregated data to a law enforcement agency in response to receiving the alert request.

20. The method of claim 15, further comprising:
detecting an emergency based on the aggregated data; and
generating an emergency notification to the client device in response to detecting the emergency.

21. A non-transitory computer-readable storage medium storing a set of instructions that, when executed by a processor, cause the processor to perform operations, comprising:
communicating with a mobile communication device introduced to a gateway by a web server based on a selection of a security monitoring service from the mobile communication device, the gateway associated with the selected security monitoring service, the mobile communication device having an optical component and a microphone for generating media data;
recording a live stream of the media data from the mobile communication device after the selection of the security monitoring service on the mobile communication device; and
aggregating the media data from the mobile communication device and monitoring data generated by a security device coupled to the gateway;
storing the aggregated data in a storage device coupled to the gateway; and
communicating the aggregated data to a client device of the gateway.
